(19) United States
(12) Patent Application Publication
(10) Pub. No.: US 2007/0140654 A1
(43) Pub. Date: Jun. 21, 2007

(54) Recording content on a record medium that contains a desired content descriptor

(75) Inventors: Eric Thelen, Aachen (DE); Dietrich Klakow, Saarbrucken (DE); Cor Luijks, Veldhoven (NL); Jan Alexis Daniel Nesvadba, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V

(21) Appl. No.: 10/576,165

(22) PCT Filed: Oct. 21, 2004
(86) PCT No.: PCT/IB04/52161

§ 371 Date: Apr. 19, 2006

(30) Foreign Application Priority Data
Oct. 24, 2003 (EP) 03103956.3

(51) Int. Cl. H04N 7/00

(52) U.S. Cl. 386/95

(57) ABSTRACT

The invention relates to a method for recording content on a record medium (2) that contains a desired content descriptor (3), comprising the steps of reading said desired content descriptor (3) from said record medium (2), scanning the content (10, 12) of at least one multimedia source (6, 7) for desired content that matches said desired content descriptor (3), and recording said desired content on said record medium (3). Said record medium (2) is preferably a Digital Versatile Disc (DVD), said desired content descriptor (3) is preferably a keyword contained in a blank of said DVD, and said at least one multimedia source (6, 7) is preferably a television receiver. The DVD with the keyword contained therein thus triggers the recording of content from the television receiver that matches said keyword on said DVD. The invention further relates to a computer program product, a device and a record medium.

This invention relates to a method, a computer program product, a device and a record medium for recording content on a record medium that contains a desired content descriptor.

Recording of analog and digital content stemming from a multimedia source as for instance a television (TV) or radio receiver on electric/magnetic/optic record media is nowadays a well-known technique. If for instance a TV event such as a movie or a show is to be recorded on a Video Cassette Recorder (VCR), the user may either manually initiate the magnetic recording of the TV event on a tape by pressing the “record” button of the VCR when the TV event is about to start, and by pressing the “stop” button when the TV event is over, or he may automatically initiate the recording by programming the VCR with the preset data, i.e. the channel number and the start and end time of the desired TV event. This technique is especially advantageous for the recording of TV events that are broadcast when the user is not at home. U.S. Pat. No. 5,379,153 A discloses an according apparatus for recording on and reproducing from a record medium events supplied at particular times from at least one source. In order to resolve recording conflicts that occur when a user programs the start and end time of two or more desired TV events that temporally overlap, so that complete recording of all programmed TV events becomes impossible, U.S. Pat. No. 5,379,153 A proposes to record the preset data on the record medium. The recorded preset data, which indicates both TV events that already have been recorded and TV events that still are to be recorded, can be reproduced from the record medium and is displayed to the user to facilitate programming of preset data for farther desired TV events.

The state-of-the-art recording techniques require that the user has precise knowledge of the TV event that he wants to record, i.e. he has to be aware that the TV event will be broadcast at all and then has to gather information on the broadcast channel and the start and end time of the TV event.

It is thus an object of the present invention to provide a method, a computer program product, a device and a record medium that allow for the recording of content without requiring particular knowledge on the presentation time and location of the content.

It is proposed that a method for recording content on a record medium that contains a desired content descriptor comprises the steps of reading said desired content descriptor from said record medium, scanning the content of at least one multimedia source for desired content that matches said desired content descriptor, and recording said desired content on said record medium. The desired content descriptor specifies the content that is to be recorded on the record carrier, which may for instance be a magnetic tape or a Digital Versatile Disc (DVD). The desired content descriptor may take the shape of a simple keyword or a list of keywords, such as a movie title or event title. However, more generic desired content descriptors can be imagined that describe a topic such as sports, news, drama, action, or similar. When the record medium is entered into a recording device such as a VCR or a DVD recorder, this desired content descriptor is read by the recording device. The recording device may be connected to at least one multimedia source, which may for instance be a TV receiver, and may have access to all the channels that can be received by the TV receiver. The recording device scans the content of the multimedia source, which may for instance comprise video and audio samples such as a TV movie or show, for parts that are characterised by the desired content descriptor. If such parts, i.e. the desired content, are found, they are recorded on the record medium. In effect, the record medium then only contains recorded content that matches the desired content descriptor. The great advantage of this technique is that the user of the recording method does no longer need to program preset data or even know that an event will be presented. Inserting the record medium containing the desired content descriptor into the recording device triggers the recording device to automatically scan all available multimedia sources for desired content. For instance, if the desired content descriptor is a movie title, the user does not even have to know when and via which multimedia source the movie will be presented, the only condition for the recording of the movie on the record medium is that the recording device has access to said multimedia source that presents the desired movie. Furthermore, if the user wishes to achieve information on a broader topic, such as sport events, movie genres or similar, the recording device may filter the multimedia source for events that match the broader topic, accordingly, which may lead to a broad collection of different events that are associated with the desired content descriptor and are recorded on said record medium. Such content may partially already be contained in the record medium.

According to the method of the present invention, it may be preferred that said desired content descriptor is already contained in a blank of said record medium. The term “blank of said record medium” is to be understood to characterise the record medium in its raw form, i.e. before a user has written or recorded any information on the record medium. The desired content descriptor thus may be defined and written on said record medium by the manufacturer of the record medium during the manufacturing process or shortly after the manufacturing process, either by the manufacturer itself or by a sub-contractor. The desired content descriptor may either be written to the record medium by the same technique that will be used for recording content on the record medium, or by a different technique. Accordingly, the location on the record medium where the desired content descriptor is written to may be a location for standard recording of content or a special location. When a user buys the blank of said record medium, the content descriptor is already contained in it, so that the user does not have to bother to care for the definition of a desired content descriptor and for the writing of said desired content descriptor on the record medium. This approach has the great advantage that, given the fact that a manufacturer of record media offers a large variety of record media with different desired content descriptors contained therein, the user can choose which content will be recorded on the record medium by buying that record medium that contains the desired content descriptor that fits his preferences best. When the user inserts said record medium into his recording device, automatic scanning of all connected multimedia sources for matching content is triggered, and matching content will be recorded on the record medium. For instance, if the user buys a DVD blank that contains the keywords “Movie: The Wizard of Oz” and inserts this DVD blank into the recording device, all multimedia sources will be scanned for this movie, and upon detection of said movie, it will be recorded on the DVD blank. In addition to the advantage that the user does not have to find out if, when and where this movie is broadcast or presented, the user basically gets a DVD of said movie without having to pay the royalties to the producer of the movie, because in public broadcasting, these royalties are covered by the broadcasting station. Thus the user only has to pay for the DVD blank with the according desired content descriptor contained therein. If content from said at least one multimedia source is liable for costs, as for instance a movie from a Pay-TV channel, the desired content descriptor contained in the DVD blank may as well contain the access code for the Pay-TV movie, which allows for the presentation or recording of the secured Pay-TV movie. In addition to the costs of the DVD blank with the desired content descriptor, the user has to pay a fee for the access code that is required to present or record said Pay-TV movie. The store that sells the DVD blank then operates as the fee collector of the Pay-TV company. Furthermore, by this approach it may also be ensured that the Pay-TV movie is recorded only once per purchased access code.

According to the method of the present invention, it may also be preferred that said desired content descriptor is not already contained in a blank of said record medium. The user then has the possibility to define a desired content descriptor of his own, or to use a pre-defined desired content descriptor that was made available to the user for instance via friends or via the internet. This desired content descriptor then can be written on said record medium by user interaction either via the same recording technique that will be used for the recording of the desired content itself, or via a different writing technique that is made available by the recording device itself or by an additional device. The user then has more degrees of freedom in defining desired content descriptors that are not offered by a manufacturer of a record medium.

According to the method of the present invention, it may be preferred that said desired content descriptor contained in said record medium cannot be further altered or augmented. When the desired content descriptor is once written on said record medium, either by the manufacturer or a sub-contractor, if the desired content descriptor is contained in a blank of said record medium, or by the user, if the desired content descriptor is not already contained in a blank of said record medium, it is fixed. This approach reduces the degrees of freedom of the user in re-defining his preferred desired content descriptor. However, for the unskilled user, the recording technique is vastly simplified, because no additional devices or menus are required in the recording device to lead the user through the process of altering or augmenting the desired content descriptor.

According to the method of the present invention, it may be preferred that said desired content descriptor contained in said record medium can be further altered and augmented. Especially when the desired content descriptor is pre-defined by a manufacturer or sub-contractor and is already contained in a blank of said record medium, it is advantageous for the skilled user to have the possibility to use the desired content descriptor that is already contained in the blank as a starting point for a more precise definition of the desired content descriptor. Referring to the above-mentioned movie example, the user may augment the keywords “Movie: The Wizard of Oz” to the more precise keywords “Movie: The Wizard of Oz; Version 1939” that now also comprises the desired version of the movie, if several versions are available.

According to the method of the present invention, it may be preferred that said desired content descriptor can be transferred from said record medium to a record medium of the same type or to a record medium of a different type. This is particularly helpful if one record medium is not sufficient to store all the desired content, or to obtain a copy of the DVD that contains said desired content descriptor.

According to the method of the present invention, it is preferred that said record medium is suited for electric and/or magnetic and/or optic recording of content. Accordingly, the recording device has to be compatible to the numerated recording techniques. For instance, application of the method in a Video Cassette Recorder (VCR), a Digital Versatile Disc (DVD) recorder, Personal Video Recorder (PVR), Digital Video Recorder (DVR) or similar recording device may be imagined.

According to the method of the present invention, it may be preferred that said desired content descriptor is a keyword or a list of keywords. A keyword list may simply define a topic or genre, such as “sports, football” or “action”.

According to the method of the present invention, it may be preferred that said desired content descriptor obeys a pre-defined content description format. Said pre-defined content description format may be a data structure which can be parameterised accordingly, for example: “Multimedia Type: Movie; Keyword/Title: “The Wizard of Oz”; Year: 1939”. Alternatively, a code may be used to identify specific events that are presented by the multimedia sources and shall be recorded on the record medium. Furthermore, said pre-defined content description format could be compatible with a format of an Electronic Programming Guide (EPG).

According to the method of the present invention, it may be preferred that said desired content descriptor comprises multimedia samples. Depending on the technique that is used for scanning the content of the multimedia sources for desired content, it may be advantageous to use audio or image samples that describe the desired content more precisely than a keyword list or a data structure, e.g. by using a short audio sequence of a desired music video of which only the audio track is available so far as a desired content descriptor.

According to the method of the present invention, it may be preferred that said desired content descriptor is a pre-defined content descriptor. The term, “pre-defined” is to be understood in a way that the definition of the desired content descriptor is not performed by-the user of the recording method. The pre-defined content descriptor may either be defined by the manufacturer of the record medium or its subcontractor, if the desired content descriptor is already contained in a blank of said record medium. If the user has the possibility to write the pre-defined content descriptor on the record medium by himself, the pre-defined content descriptor may be made available to the user via the internet or via super-distribution among friends. Once again it is advantageous that the user does not have to bother to define the desired content descriptor by himself.

According to the method of the present invention, it may be preferred that said desired content descriptor is defined by the user of said method. The user then has more degrees of freedom in defining desired content descriptors that are not offered by a manufacturer/sub-contractor of a record medium.

According to the method of the present invention, it may be preferred that said content from at least one multimedia source comprises image and/or audio and/or text information. Said information may for instance be videos, audio samples or web sites from an intranet or the internet.

According to the method of the present invention, it is preferred that said at least one multimedia source is a receiver for television and/or radio programs. Said receiver may be capable of receiving said programs via cable, satellite or broadcast. It may also be capable of receiving and decoding Pay-TV channels and similar content that is liable for costs.

According to the method of the present invention, it is preferred that said at least one multimedia source is a device that is connected to a computer network, in particular to the internet. Connections to an intranet or the internet may be advantageous to perform searching for documents and web pages. Also a connection to a service or device that offers an Electronic Programming Guide (EGP) might be offered via said at least one multimedia source.

According to the method of the present invention, it is preferred that said step of scanning the content of said at least one multimedia source for said desired content comprises image and/or audio and/or word processing. If the desired content descriptor is a list of keywords, the content that may be represented by image and/or audio and/or text information has to be transformed into a representation that allows to decide if the desired content descriptor matches the content. For example, if the content comprises audio information, it may be advantageous to perform some kind of speech recognition to transform the audio samples into a textual representation, and then to scan the textual representation for the keywords. This technique is also applicable for video information with an accompanying soundtrack. However, also image-based content recognition is possible by means of image recognition techniques, especially when the desired content descriptor comprises an image or short video sequence. If the content consists of text only, it may nevertheless be necessary to transform the text representation into a different text representation that is more suitable for filtering for the desired content descriptor, e.g. the transformation of Hypertext Markup Language (HTML) pages into plain text format. Said image and/or audio and/or word processing techniques may be applied to the incoming content in real time, or the content from the at least one multimedia source may be temporarily stored for further image and/or audio and/or word processing. Said step of scanning the content may also comprise the consultation of Electronic Programming Guides (EPG) in order to detect desired content.

According to the method of the present invention, it may be preferred that said step of scanning the content of said at least one multimedia source for said desired content is performed dynamically depending on the available amount of content and/or on the already recorded content. This may involve the assignment of priorities to matching content depending on the quality of the match. For instance, on the blank record medium, content that is only loosely associated with the desired content descriptor (low priority) is recorded in order to ensure that the user is not disappointed if no matching content was found at all. However, in the continuation of the scanning process, it might well be possible that better matching content is found (high priority). If the space on the record medium is getting scarce, the recording device might then decide that the previously recorded loosely matching content has to be deleted in order to allow for the recording of closely matching content. In the scanning operation, it may further be possible to detect multiple presentations of the same desired content to avoid multiple recordings. It may further be possible to automatically adjust the thresholds of the function that determines if scanned content matches the desired content descriptor in order to ensure appropriate coverage. In the context of word processing, this approach may for instance comprise ignoring of case sensitivity or clerical errors. Even further, semantic matching techniques that broaden the scope of keywords that actually served as desired content descriptor may be applied. For instance, a kind of thesaurus can be applied to construct a list of further keywords that are added to the keyword as originally represented by the desired content descriptor. If the keyword was “monkey”, semantic matching might extend the scope of matching also to “monkey, simian, anthropoid, chimpanzee, gorilla”. Accordingly, techniques such as the Semantic Web technology as used in the World Wide Web (WWW) could be applied. This semantic matching is particularly advantageous in combination with the above-mentioned approach of assigning the matching content priorities according to the closeness of the match. Furthermore, it may be necessary to be aware of already recorded content in order to be able to delete recorded content if scanned content that better matches the desired content descriptor is found.

It is further proposed that a computer program product directly loadable into the internal memory of a digital computer comprises software code portions for performing the method steps of any of the preceding method steps when said product is run on a computer. Said digital computer may for instance be the central processing unit of the recording device.

It is further proposed that a device for recording content on a record medium that contains a desired content descriptor comprises means for reading said desired content descriptor from said record medium, means for scanning the content of at least one multimedia source for desired content that matches said desired content descriptor; and means for recording said desired content on said record medium. Said device may for instance be a Video Cassette Recorder (VCR), a Digital Versatile Disc (DVD) recorder, a Personal Video Recorder (PVR), a Digital Video Recorder (DVR) or a similar recording device, wherein said recording devices have enhanced functionality to perform the reading of the desired content descriptor and the scanning of the content from the multimedia sources. If the desired content descriptor can be written on;said record medium by user interaction, further functionality to perform the writing operation has to be included in the device as well.

According to the device of the present invention, it is preferred that said means for scanning the content of said at least one multimedia source for said desired content comprises means for image and/or audio and/or word processing. These means may for instance comprise further storage means for temporarily storing the incoming content from the multimedia sources.

It is further proposed that a record medium contains a desired content descriptor, wherein said desired content descriptor can be read from said record medium to trigger the scanning of content of at least one multimedia source for desired content that matches said desired content descriptor and that is recorded on said record medium.

Said record medium may contain said desired content descriptor either within the standard recording location, where all content is normally recorded, or in a special location. Furthermore, the desired content descriptor may be written to said record medium by a technique that differs from the technique with which content is recorded on said record medium. For instance, keywords may be optically written on a special field of a magnetic video tape or optic DVD by means of a bar code that can be read by the recording device.

According to the record medium of the present invention, it may be preferred that said record medium is suited for electric and/or magnetic and/or optic recording of content. Said record medium thus may for instance be embodied as a magnetic tape, or a DVD, or a hard disc of a PVR or DVR.

These and other aspects of the invention will be apparent from and elucidated with reference to the embodiments described hereinafter. In the figures show:

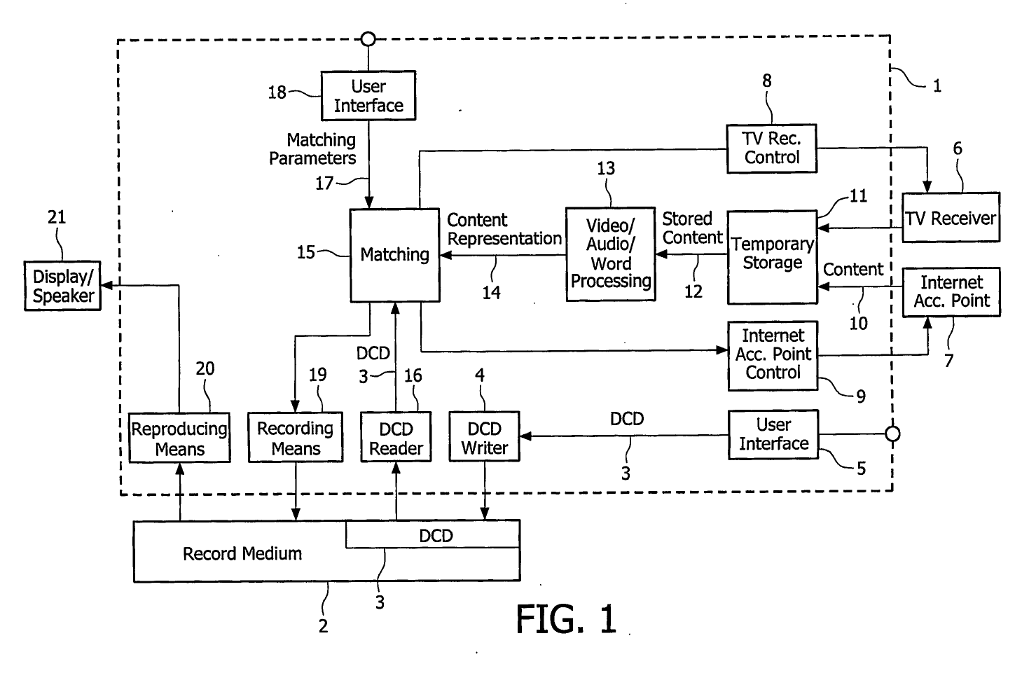

FIG. 1: A schematic representation of a device for recording desired content according to the present invention.

FIG. 1 schematically depicts the basic components of an embodiment of a recording device 1 for recording desired content on a record medium 2, which contains a Desired Content Descriptor (DCD) 3. In a preferred embodiment, the device 1 is embodied as a DVD recorder, and the record medium 2 is embodied as a DVD 2 containing said desired content descriptor 3, for instance as coded information written into the track of the DVD during its manufacturing process. Alternatively, the desired content descriptor 3 may be written to said DVD 2 by the desired content descriptor writer 4 according to an input to the recording device 1 via a user interface 5. Said desired content descriptor 3 then may either be defined by the user itself or may be made available to the user via a distribution source as for instance the internet. For the present embodiment 1, it is assumed that said desired content descriptor 3 is a list of keywords, namely “Champions League soccer matches 2003, full recordings, comments, results, goals, background information”, that has been written on said DVD 2 during its manufacturing process. The user of the method has bought the DVD blank 2 containing said desired content descriptor 3 because he wants to record as much information as possible on the topic of the Champions League soccer matches of the year 2003.

The recording device 1 has an interface to a TV receiver 6 and an internet access point 7, which serve as multimedia sources that can be scanned for content matching said desired content descriptor 3. The TV receiver may for instance be a tuner that can be tuned to different television and radio channels that are received via a cable, satellite or broadcast connection. The TV receiver may further comprise functionality to decode Pay-TV channels, possibly with an access code that was contained in the desired content descriptor of the DVD blank 2, and to recover additional information accompanying the TV or radio programs, such as textual information on the TV or radio program or news. Such additional information may be modulated on the same or a different frequency carrier that carries the TV or radio channel, and may be further processed to detect desired content as will be described below. In particular, the TV receiver 6 may provide access to an Electronic Programming Guide (EPG). The control of the TV receiver 6 is accomplished by the TV receiver control unit 8, which may allow to tune the TV receiver 6 to different TV or radio channels. The recording device 1 may also be connected to a plurality of such TV receivers 6, with a single TV receiver control unit 8 or a plurality of TV receiver control units 8. The internet access point 7 may be a computer that is connected to the internet. It is controlled by an internet access point control unit 9 that provides a browsing and searching functionality, so that a plurality of web pages, which may in turn comprise video, audio or text and are found via said internet access point 7.

Content 10 from said TV receiver 6 and said internet access point 7 is continuously stored in the temporary storage unit 11. This temporary storage unit 11 is optional. The stored content 12 or, when no temporary storage unit 11 is required, the content 10, is continuously transferred to the video/audio/word processing unit 13. In this unit, the incoming content 10/12 is transferred into a content representation 14 that allows the matching unit 15 to compare the desired content descriptor 3 with the content 10/12 in order to determine the content that matches said desired content descriptor 3. The desired content descriptor 3 is made available to the matching unit 15 via the desired content descriptor reader 16, which automatically reads the desired content descriptor when the DVD 2 is inserted into the recording device 1.

For the present embodiment, the content as received from the TV receiver 6 is subject to audio and/or image processing. For instance, if the TV receiver 6 is switched to a radio channel under the control of the TV receiver control unit 8, speech recognition techniques are applied by the video/audio/word processing unit 13 in order to create a representation of the audible content that can be compared to the textual desired content descriptor 3 by the matching unit 15. Quite similar, if the TV receiver 6 is switched to a TV channel by the TV receiver control unit 8, mainly speech recognition of the audio track of the TV program will be applied to create a content representation 14 that can be understood by the matching unit. However, it may further be advantageous to perform image recognition techniques on the video track contained in the TV program, for instance to allow the matching unit 15 to discover words like “Champions League” or similar in the content representation 14. Furthermore, the content 10/12 stemming from the internet access point 7 may be processed by the video/audio/word processing unit 13 in order to generate a content representation 14 of the HTML pages in raw text format or with HTML tags being removed from the text representation.

The matching unit 15 actually decides if the content representation 14 matches the desired content descriptor 3. If the content representation 14 is text as yield from speech recognition or HTML-to-text conversion, and if the desired content, descriptor 3 is a list of keywords as in the present embodiment, a match is easily decided, for instance the matching unit can decide that desired content is found when one or two of the keywords are found -in the content representation 14. In this case, the matching unit 15 triggers the recording of the desired content on the record medium 3 via the recording means 19, in the present embodiment the writing head of the DVD recorder.

The threshold of the matching unit 15, for instance the number of keywords that have to be matched by a content representation 14, can be further influenced by matching parameters 17, which can be entered via a further user interface 18. These matching parameters 17 may be set to configure a wider or narrower matching procedure, in particular if semantic matching techniques are applied. Such semantic matching techniques may comprise the ignoring of case sensitivity and clerical errors in keywords or content, the application of a thesaurus and the Semantic Web technology as used in the World Wide Web. Referring to the example of the “Champions League” keyword list, the recording may be triggered even if the content representation 14 does not contain the phrase “Champions League”, but only the names of the playing teams. From other context information on the Champions League, the participating teams and the schedule, the semantic matching procedure would be able to infer that this program must be one of the Champions League matches. The matching unit 15 may advantageously be dynamic with respect to the available content and the already recorded content. If a lot of content is available via the TV receiver 6 and the internet access point 7, the matching procedure can be narrower, e.g. the number of keywords that have to be jointly detected in the content representation 14 has to be larger. If content is multiply detected in different TV channels or at different times, the matching unit 15 advantageously provides functionality to avoid the duplicate recording of such content to save space on the DVD 2. Furthermore, the matching unit 15 may be capable of assigning the detected content a priority, for instance with respect to the number of keyword matches of the content representation 14, and to delete previously recorded low priority content if a lot of high priority content is found afterwards and if DVD space is getting scarce. The matching unit 15 further possesses functionality to control the TV receiver control unit 8 and the internet access point control unit 9. Thus stepping through the available TV and radio channels and searching different web pages can be initiated by the matching unit 15 to allow for an optimum scan of the available multimedia sources 6 and 7.

Finally, the recording device 1 possesses a reproducing means 20 that allows to reproduce the recorded contents. To this end, the reproducing means 20 comprises a means for reading the content from the record medium 2 and an interface to a display and/or speaker unit 21 on which the recorded content can finally be presented.

The invention has been described above by means of a preferred embodiment. It should be noted that there are alternative ways and variations which are obvious to a skilled person in the art and can be implemented without deviating from the scope and spirit of the appended claims, e.g. the recording device 1 may be a magnetic recording device such as a VCR or an electronic recording device such as a DVR. The reading and writing of the desired content descriptors 3 on the record medium 2 can be performed by the reproducing means 20 and recording means 19, respectively, instead of the additional desired content descriptor reader 16 and writer 4. Instead of a list of keywords, an image of audio sample may be defined as desired content descriptor. Finally, the components required to perform the method of the present invention may be implemented as add-on components to a state-of-the-art recording device, or may be integrated into a new product. Furthermore, the integration of recording device, TV receiver and display/speaker into one device is also possible.

1. A method for recording content on a record medium (2) that contains a desired content descriptor (3), comprising the steps of: reading said desired content descriptor (3) from said record medium (2); scanning the content (10, 12) of at least one multimedia source (6, 7) for desired content that matches said desired content descriptor (3); and recording said desired content on said record medium (3).

2. The method according to claim 1, wherein said desired content descriptor (3) is already contained in a blank of said record medium (2).

3. The method according to claim 1, wherein said desired content descriptor (3) is not already contained in a blank of said record medium (2).

4. The method according to claim 1, wherein said desired content descriptor (3) contained in said record medium (2) cannot be further altered or augmented.

5. The method according to claim 1, wherein said desired content descriptor (3) contained in said record medium (2) can be further altered and augmented.

6. The method according to claim 1, wherein said desired content descriptor (3) can be transferred from said record medium (2) to a record medium (2) of the same type or to a record medium (2) of a different type.

7. The method according to claim 1, wherein said record medium (2) is suited for electric and/or magnetic and/or optic recording of content.

8. The method according to claim 1, wherein said desired content descriptor (3) is a keyword or a list of keywords.

9. The method according to claim 1, wherein said desired content descriptor (3) obeys a pre-defined content description format.

10. The method according to claim 1, wherein said desired content descriptor (3) comprises multimedia samples.

11. The method according to claim 1, wherein said desired content descriptor (3) is a pre-defined content descriptor.

12. The method according to claim 1, wherein said desired content descriptor (3) is defined by the user of said method.

13. The method according to claim 1, wherein said content (10, 12) from at least one multimedia source (6, 7) comprises image and/or audio and/or text information.

14. The method according to claim 1, wherein said at least one multimedia source (6, 7) is a receiver (6) for television and/or radio programs.

15. The method according to claim 1, wherein said at least one multimedia source (6, 7) is a device (7) that is connected to a computer network, in particular to the internet.

16. The method according to claim 13, wherein said step of scanning the content (10, 12) of said at least one multimedia source (6, 7) for said desired content comprises image and/or audio and/or word processing.

17. The method according to claim 1, wherein said step of scanning the content (10, 12) of said at least one multimedia source (6, 7) for said desired content is performed dynamically depending on the available amount of content (10, 12) and/or on the already recorded content.

18. A computer program product directly loadable into the internal memory of a digital computer, comprising software code portions for performing the method steps of claim 1 when said product is run on a computer.

19. A device (1) for recording content (10, 12) on a record medium (2) that contains a desired content descriptor (3), comprising: means (16) for reading said desired content descriptor (3) from said record medium (2); means (13, 15) for scanning the content (10, 12) of at least one multimedia source (6, 7) for desired content that matches said desired content descriptor (3); and means (18) for recording said desired content on said record medium (2).

20. The device (1) according to claim 19, wherein said means for scanning (13, 15) the content (10, 12) of said at least one multimedia source (6, 7) for said desired content comprises means (13) for image and/or audio and/or word processing.

21. A record medium (2) containing a desired content descriptor (3), wherein said desired content descriptor (3) can be read from said record medium (2) to trigger the scanning of content (10, 12) of at least one multimedia source (6, 7) for desired content that matches said desired content descriptor (3) and that is recorded on said record medium (2).

22. The record medium (2) of claim 21, wherein said record medium (2) is suited for electric and/or magnetic and/or optic recording of content.
